(19) United States
(12) Patent Application Publication
(10) Pub. No.: US 2008/0301466 A1
(43) Pub. Date: Dec. 4, 2008

(54) METHODS FOR PROGRAM VERIFICATION AND APPARATUSES USING THE SAME

(75) Inventors: Chia-Jung Hsu, Taipei City (TW); Ching-Lin Hsu, Tai-Chung Hsien (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 12/061,680

(22) Filed: Apr. 3, 2008

Related U.S. Application Data
(60) Provisional application No. 60/940,705, filed on May 30, 2007.

(51) Int. Cl. H04L 9/28; G06F 9/44

(52) U.S. Cl. 713/189; 717/168

(57) ABSTRACT

An embodiment of an apparatus for downloading and/or executing programs from a tool resident on a computer host is disclosed. The apparatus comprises an external flash memory storing a program, and a processor for validating the tool when detecting that the computer host connects to the apparatus. The processor permits the computer host to update the program of the external flash memory after determining that the tool has been successfully verified.

### CROSS REFERENCE TO RELATED APPLICATIONS

This application claims the benefit of U.S. Provisional Application No. 60/940,705 filed on May 30, 2007 “DEVELOPER AUTHENTICATION SYSTEM AND METHOD”

### BACKGROUND OF THE INVENTION

1. Field of the Invention

The invention relates to a validation mechanism executed by an apparatus to validate programs from a computer host.

2. Description of the Related Art

Currently increased utilization of electronics devices, such as cell phones, has generated a growing demand for measures to assure data and software security. For conventional designs, the system software embedded in the electronics device is easily replaced, cloned or hacked due to the lack of authorization mechanisms. To solve this issue, most solutions pre-burn developer information into the chip embedded in electronic devices. However, this increases process complexity and causes stock issues for the chip vendor.

### BRIEF SUMMARY OF THE INVENTION

An exemplary embodiment of an apparatus for downloading and/or executing programs from a tool resident on a computer host is disclosed. The apparatus comprises an external flash memory storing a program and a processor for validating the tool when detecting that the computer host has connected to the apparatus. The processor permits the computer host to update the program of the external flash memory after determining that the tool has been successfully verified.

Another embodiment of a verification method for a tool resident on a computer host is disclosed, wherein the apparatus downloads and/or executes programs from the tool. The method comprises the following steps: transmitting a code object comprising content and a encrypted value to the apparatus; gaining permission to update a program of the apparatus after the apparatus determines that the content matches the encrypted value; and updating programs of the apparatus when obtaining the permission.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic diagram of an electronic device with a verification mechanism.

FIG. 2 is a flowchart of an authentication method executed by a boot ROM program after the mobile phone is turned on.

FIG. 3 is a schematic diagram of the process for the generation of the code object which is applied in a first embodiment of the validation mechanism according to the invention.

FIG. 4 is a flowchart of the process for the generation of the code object which is applied in the first embodiment of the validation mechanism according to the invention.

FIG. 5 is a flowchart of an embodiment of the verification of the code object according to the invention.

FIG. 6 is a schematic diagram of the process for the generation of the authentication file which is applied in a second embodiment of the validation mechanism according to the invention.

FIG. 7 is a flowchart of the process for the generation of the authentication file which is applied in the second embodiment of the validation mechanism according to the invention.

FIG. 8 is a schematic diagram showing the second embodiment of the validation mechanism between an electronic device and a computer host.

FIG. 9 is a flowchart of an embodiment of the verification of the authentication file according to the invention.

FIG. 10 is a flowchart of an embodiment of the challenge procedure according to the present invention.

FIG. 11 is a schematic diagram of the process for the generation of the authentication file which is applied in a third embodiment of the validation mechanism according to the invention.

FIG. 12 is a flowchart of the process for the generation of the code object which is applied in the third embodiment of the validation mechanism according to the invention.

FIG. 13 is a flowchart of another embodiment of the verification of the authentication file according to the invention.

FIG. 14 is a flowchart of an embodiment of the customer information validation procedure according to the present invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

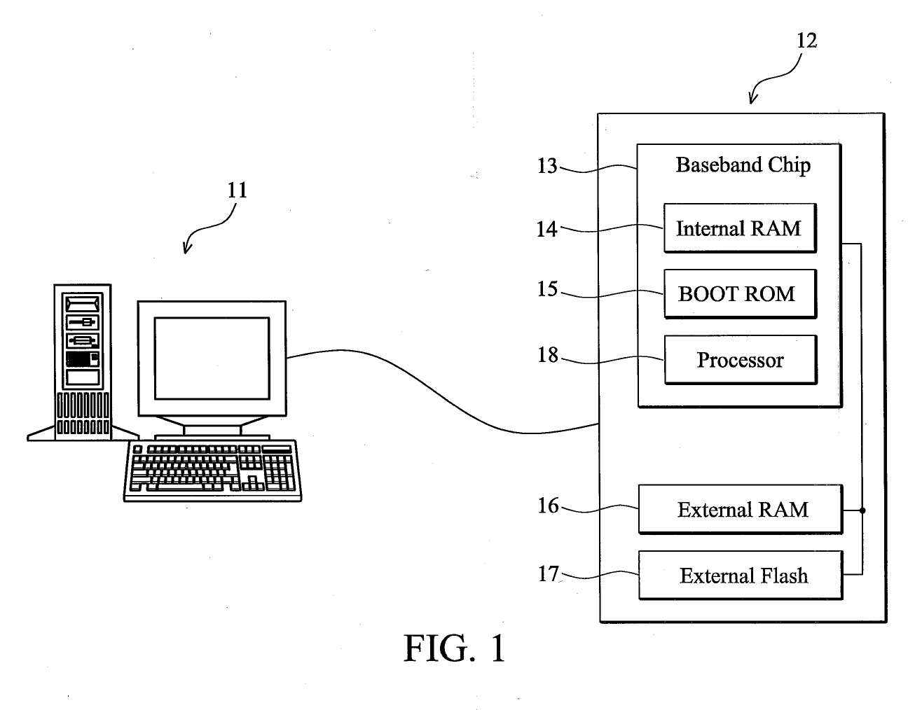

FIG. 1 is a schematic diagram of an electronic device with a verification mechanism. In FIG. 1, the electronic device is illustrated with a mobile phone 12, but does not limit the invention thereto. The mobile phone 12 comprises a baseband chip 13 comprising an internal RAM 14 and a boot ROM 15, an external RAM 16 and an external flash memory 17. The boot ROM (or called boot loader) 15 stores and executes programs when the mobile phone 12 is turned on (or powered on). The boot ROM 15 further stores an authentication program to validate a tool resident on a computer host 11. When the mobile phone 12 is turned on, the baseband chip 13, when executing the authentication program, detects whether the mobile phone 12 is connected to the computer host 11. If the mobile phone 12 is not connected to the computer host 11, the baseband chip 13 executes programs stored in the external flash 17 or the external RAM 14, such as mobile phone applications. If the baseband chip 13 detects that the mobile phone 12 is connected to the computer host 11, the baseband chip 13 validates the tool and transfers the control to the computer host 11 after determining that the tool has been successfully verified.

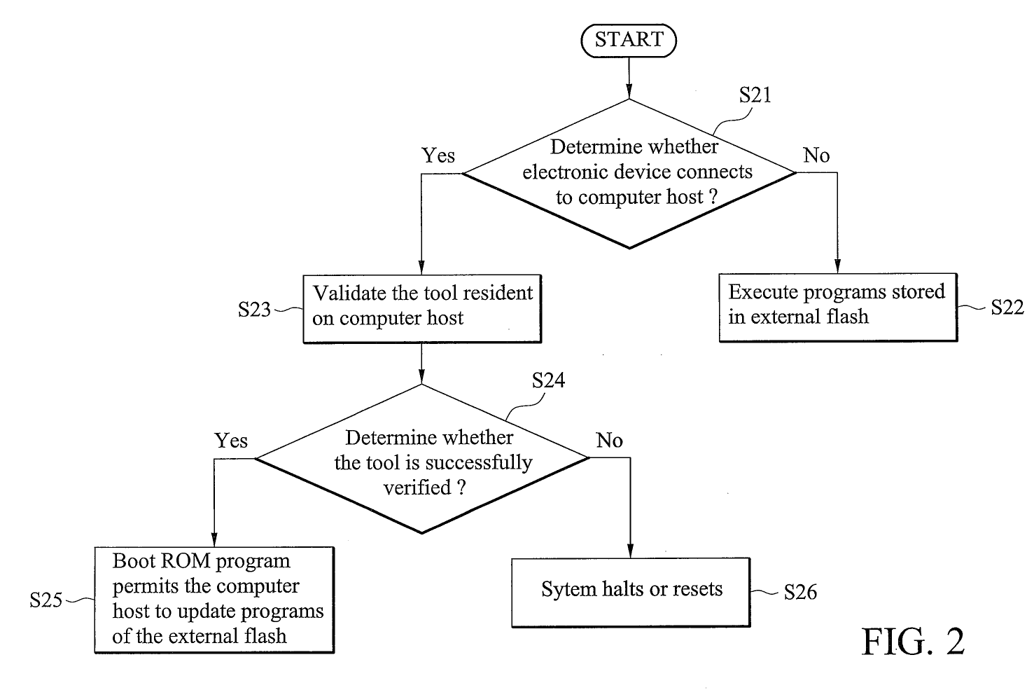

FIG. 2 is a flowchart of an authentication method executed by a boot ROM program after the mobile phone is turned on. In step S21, the boot ROM program detects whether the mobile phone connects to a computer host or other similar electronic device. If not, the boot ROM program executes the programs stored in the external flash memory in the step S22, wherein the programs comprise system boot-up, operating system, or mobile phone applications. If yes, the boot ROM program validates the tool resident on the computer host in step S23. In step S24, the boot ROM program validates whether the tool is authenticated for the mobile phone. If yes, the boot ROM program permits the computer host to update programs of the external flash 17 in step S25. If not, the boot ROM program resets the mobile phone or halts operation in step S26. After the computer host is permitted, the computer host may issue one or more write commands to the boot ROM program to write a download agent (DA) to an internal RAM 14, and instruct the boot ROM program to jump to program code of the DA. After that, the DA, when executing, interacts with the computer host to refresh programs stored in external flash 17.

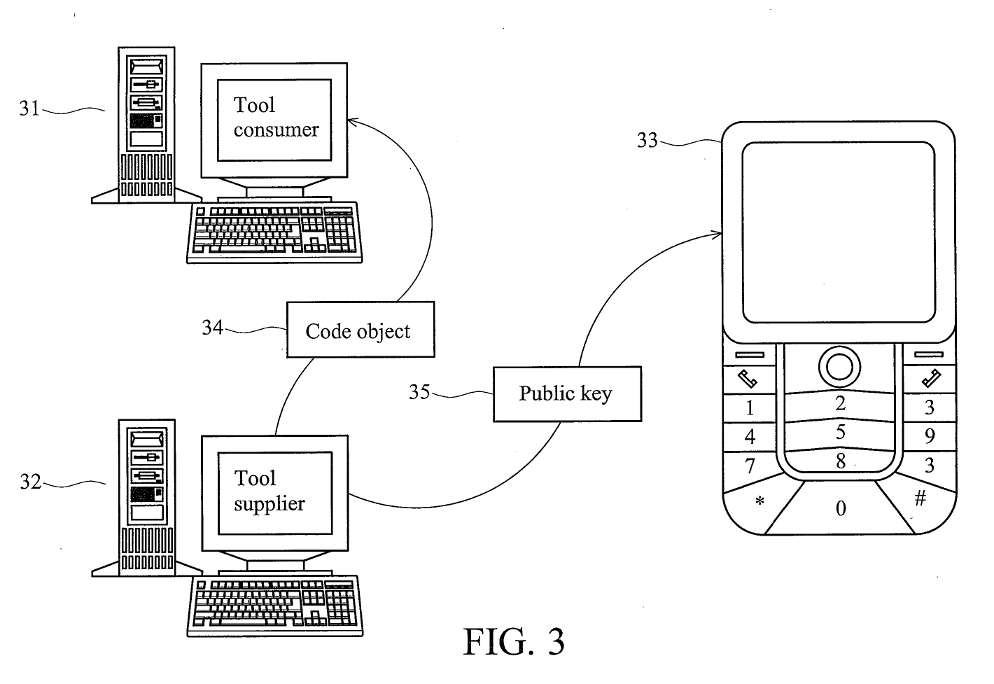

FIG. 3 is a schematic diagram of the process for the generation of the code object which is applied in a first embodiment of the validation mechanism according to the invention. In this embodiment, the validation mechanism is applied between the mobile phone 33 and the tool consumer 31, and the tool supplier 32 generates and transmits code object 34 to the tool consumer 31. The tool supplier 32 further generates a pair of a public key 35 and a private key using a key generator and transmits the public key 35 to the mobile phone 33. The public key 35 is stored in the boot ROM, internal ROM, internal RAM, external RAM or external flash inside the mobile phone 33. The code object 34 comprises two parts, content and encrypted value, wherein the content may comprise authentication files or target programs which the tool consumer 31 wants to execute in the mobile phone 33, or the combination. Details of encrypted value generation are described in the following. The tool supplier 32 uses a hash function to generate a hash value of the content. The hash function turns a variable-sized of one or more target programs into a fixed-sized and relatively small-sized output (i.e. hash value) served as a digital “fingerprint” of the target programs. Then, the tool supplier 32 uses the generated private key to encrypt the hash value so as to generate the encrypted value.

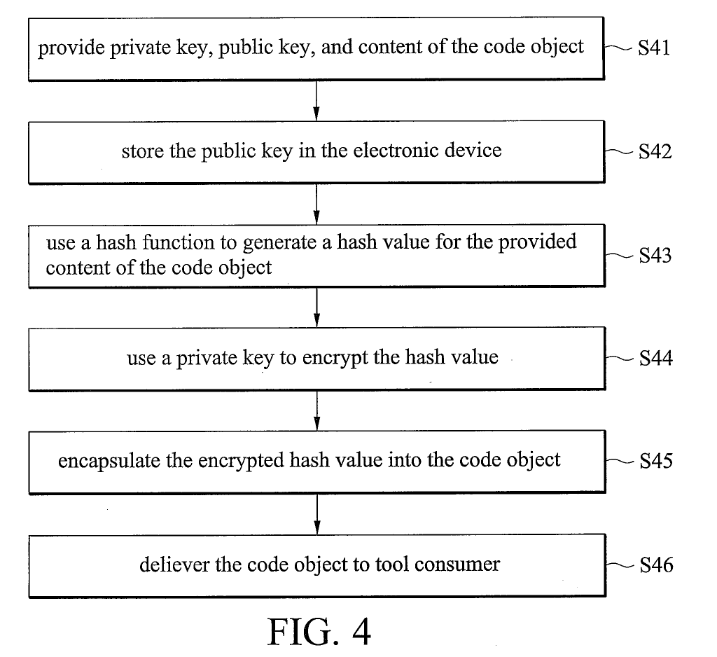

FIG. 4 is a flowchart of the process for the generation of the code object which is applied in the first embodiment of the validation mechanism according to the invention. In the embodiment, the flowchart is illustrated with the elements shown in FIG. 3. In step S41, the tool supplier provides the private key and the public key, and the content of the code object. In step S42, the tool supplier 32 stores the public key in the mobile phone 33, wherein the public key is pre-burned in a ROM of the mobile phone 33 or is programmed in the boot-up program of the mobile phone 33. In step S43, the tool supplier generates a hash value for the provided content by using a hash function, wherein the hash function can be implemented by software or hardware. After the hash value is generated, the tool supplier 32 encrypts the hash value by using the private key in step S44. In the step S45, the tool supplier 32 then encapsulates the target programs and the encrypted value into the code object and delivers the code object 34 to the tool consumer 31 in step S46.

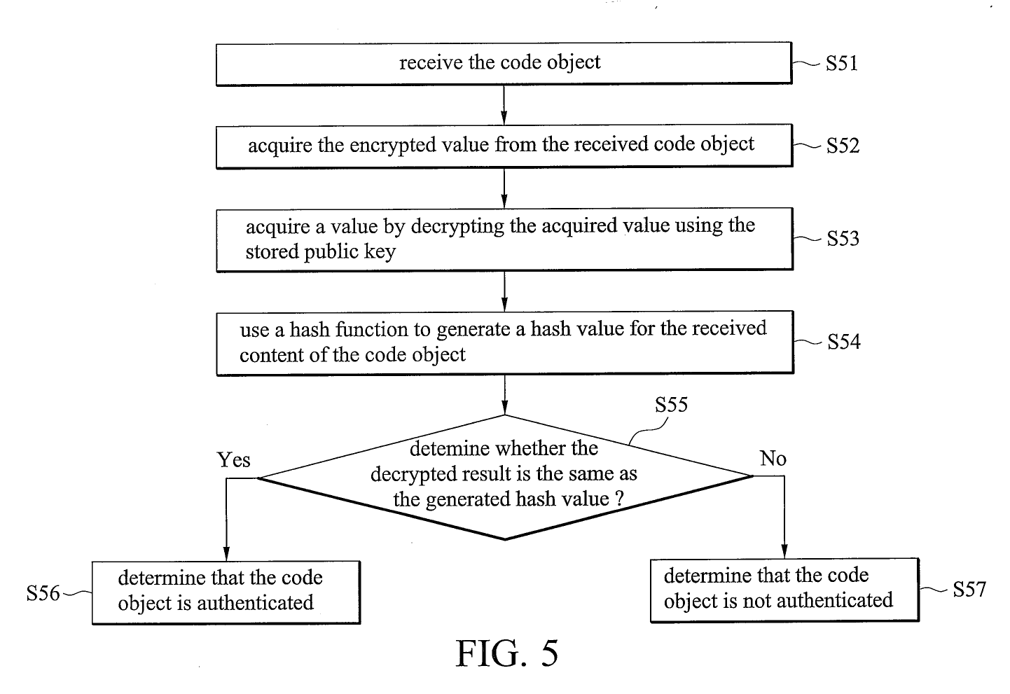

FIG. 5 is a flowchart illustrating an embodiment of the verification of the code object according to the invention. In the embodiment, the flowchart is illustrated with the elements shown in FIG. 1. When the mobile phone 12 detects that the mobile phone 12 is connected to the computer host 11, the verification procedure is applied. In the step S51, the baseband chip 13 receives the code object from the computer host 11 and acquires the encrypted value from the received code object in the step S52. The baseband chip 13 then uses the stored public key to decrypt the encrypted value to acquire a first value in the step S53. In step S54, the baseband chip 13 generates a hash value by performing the hash function to the content of the code object, wherein the hash function is the same as the described hash function in FIGS. 3 and 4. In the step S55, the baseband chip 13 determines whether the first value is the same as the hash value. If yes, the procedure jumps to step S56. If not, the procedure jumps to step S57. In the step S56, the code object is authenticated and the baseband chip 13 transfers the control to the computer host 11. In the step S57, the code object is not authenticated and the baseband chip 13 resets or halts operation of the mobile phone 12. When obtaining the control, the computer host 11 may update target programs of the mobile phone 12.

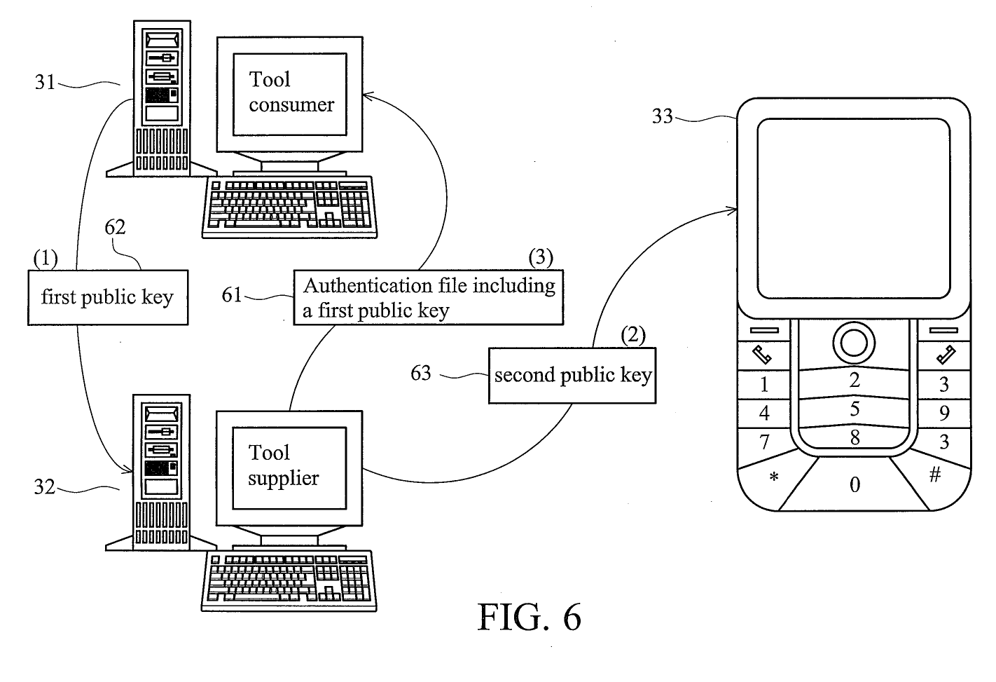

FIG. 6 is a schematic diagram of the process for the generation of an authentication file which is applied in a second embodiment of the validation mechanism according to the invention. In this embodiment, the validation mechanism is applied between the mobile phone 33 and the tool consumer 31. The tool consumer 31 generates a pair of a first public key 62 and a first private key using a key generator and transmits the first public key 62 to the tool supplier 32. The tool supplier 32 subsequently prepares a certificate comprising the first public key 62, and target programs which the tool consumer 31 wants to execute in the mobile phone 33. The tool supplier 32 generates a pair of a second public key 63 and a second private key using a key generator, and transmits the second public key 63 to the mobile phone 33. The second public key 62 is stored in the boot ROM, internal ROM, internal RAM, external RAM or external flash inside the mobile phone 33. Moreover, the tool supplier 32 uses a hash function to generate a hash value of the prepared certificate and uses the second private key to encrypt the hash value so as to generate a signature of the prepared certificate. The tool supplier 32 then encapsulates the certificate and the generated signature into an authentication file 61 and transmits the authentication file 61 to the tool consumer 31.

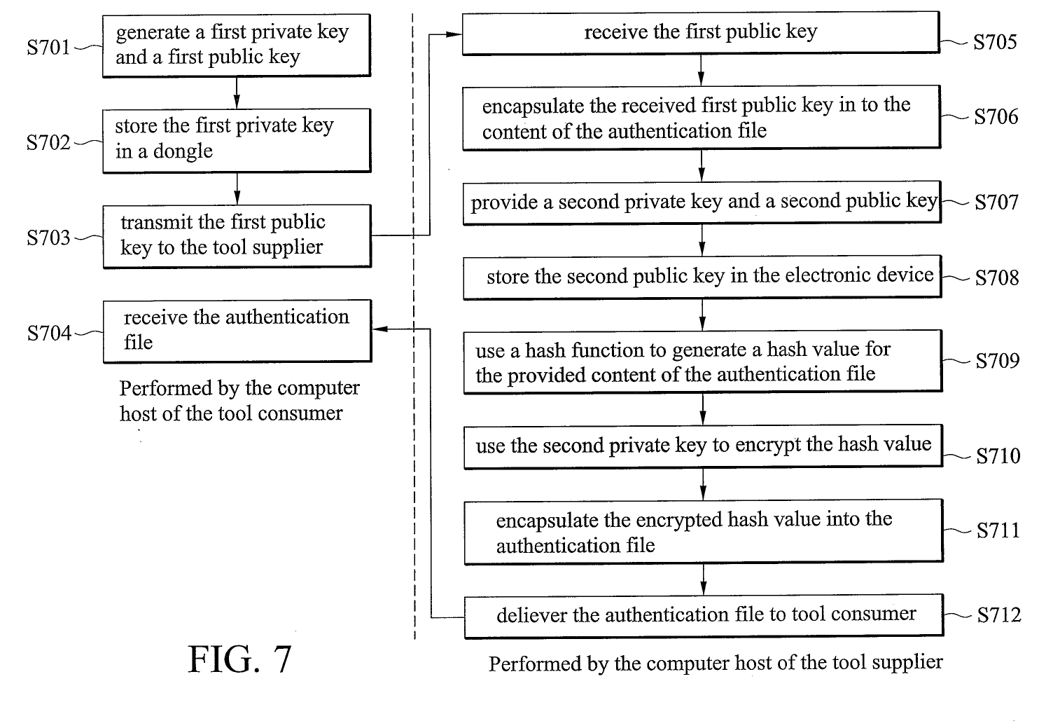

FIG. 7 is a flowchart illustrating the process for the generation of the authentication file which is applied in the second embodiment of the validation mechanism according to the invention. In the embodiment, the flowchart is illustrated with the elements shown in FIG. 6. The steps S701 to S704 is performed by a computer host of the tool consumer and the steps S705 to S711 is performed by a computer host of the tool supplier. In the step S701, the tool consumer 31 generates a pair of a first private key and a first public key 62, and stores the first private key in a dongle or a hard drive of the computer host of the tool consumer 31. The dongle is a hardware device that serves as download protection for target programs by directing the authentication mechanism failed when the device is not plugged into a particular port. In step S703, the tool consumer 31 transmits the first public key 62 to the tool supplier 32. When the tool supplier 32 receives the first public key 62 in step S705, the tool supplier 32 encapsulates the first public key into the content of the authentication file 61. In step S707, the tool supplier 32 generates a pair of a second private key and a second public key 63, and stores the second public key 63 in the mobile phone 3 at step S708. In step S709, the tool supplier 32 generates a hash value of the content of the authentication file 61 by using a hash function, wherein the hash function can be implemented by software or hardware. After the hash value is generated, the tool supplier 32 encrypts the hash value by using the second private key in step S710. In the step S711, the tool supplier 32 then encapsulates the encrypted hash value into the authentication file 61 and delivers the authentication file 61 to the tool consumer 31 in the step S712.

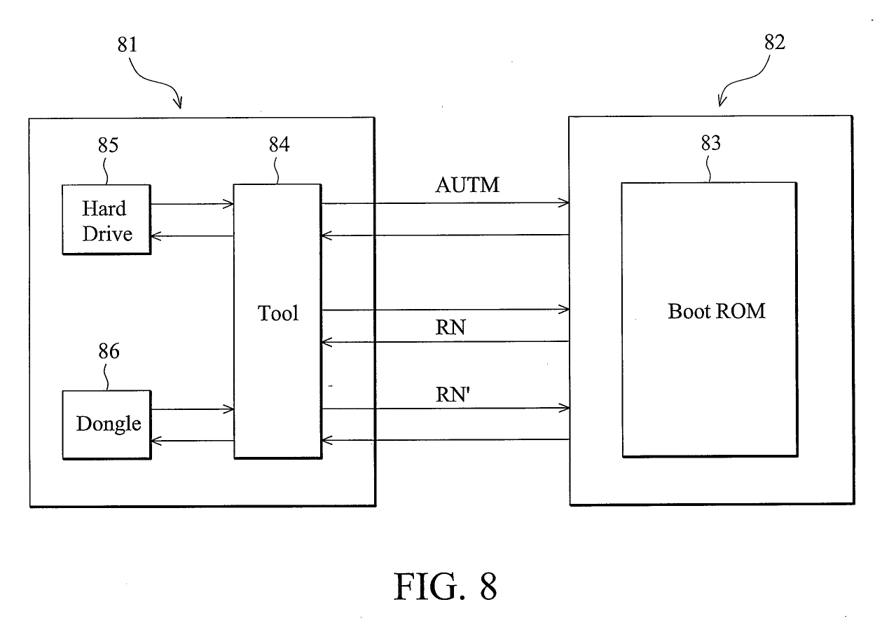

FIG. 8 is a schematic diagram showing the second embodiment of the validation mechanism between an electronic device and a computer host. The electronic device 82 comprises boot ROM 83. The computer host 81 comprises a hard drive 85, a dongle 86, and a tool 84 executed by the computer host 81. When a boot ROM program stored in the boot ROM 83, when executed by a processor, detects that the computer host 81 is connected to the electronic device 82, the boot ROM program executes a validation procedure, AUTH, to the tool 84 of the computer host 81. If the validation procedure for the tool 84 passes, the boot ROM program executes a re-validation procedure for the tool 84. If the validation procedure for the tool 84 does not pass, the boot ROM 83 resets or halts operation of the electronic device 82. The re-validation procedure (or called challenge procedure) is illustrated as the following. The boot ROM program first generates and stores a random number RN and transmits the random number RN to the tool 84. When receiving the random number RN, the tool 84 executed by a processor encrypts the random number RN by using a private key stored in the hard drive 85 or dongle 86, and the tool 84 then transmits the encrypted random number RN′ to the boot ROM 83. When the boot ROM program receives the encrypted random number RN′, the boot ROM program decrypts the encrypted random number RN′ by using a public key stored in the electronic device 82. The boot ROM program determines whether the decrypted result is the same as the random number RN. If yes, the boot ROM program transfers the control to the tool 82. If not, the boot ROM program resets the electronic device 82 or halts operation of the electronic device 82.

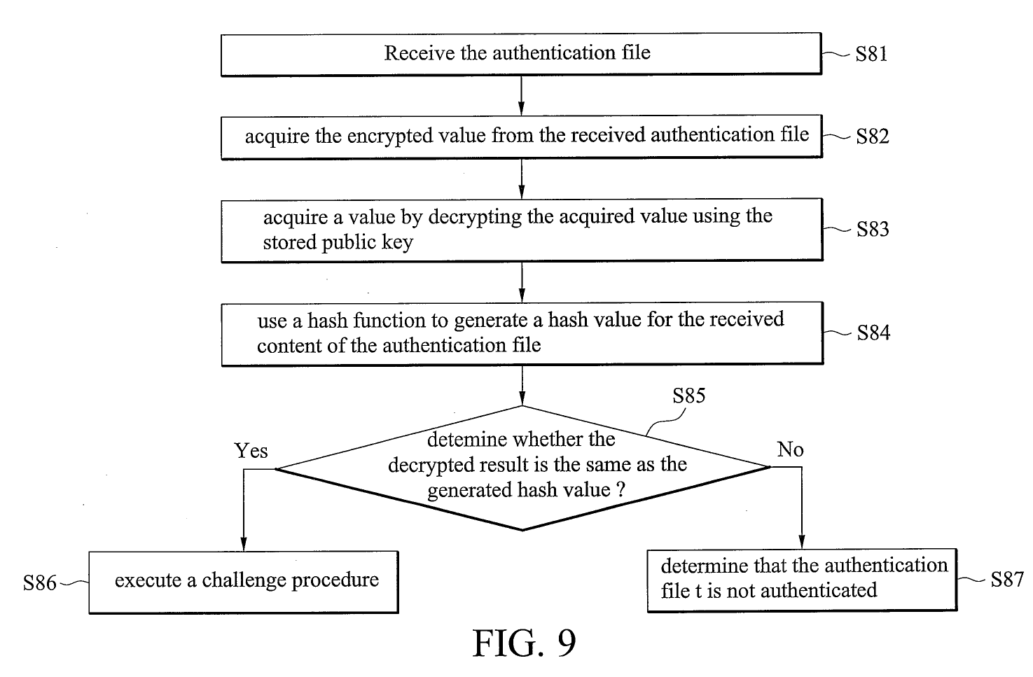

FIG. 9 is a flowchart of an embodiment of the verification of the authentication file according to the invention. In the embodiment, the flowchart is illustrated with the elements shown in FIG. 8. When the electronic device 82 detects that the electronic device 82 is connected to the computer host 81, the verification procedure is applied. In the step S81, the boot ROM program receives an authentication file from the computer host 81 and acquires the encrypted value from the received authentication file in the step S82. The authentication file may be generated using the process illustrated in FIG. 7. The boot ROM program then uses the stored public key (may be the second public key of FIG. 7) to decrypt the encrypted value to acquire a first value in the step S83. In step S84, the boot ROM program generates a hash value for the content of the authentication file by using a hash function. In the step S85, the boot ROM 83 determines whether the first value is the same as the hash value. If yes, the procedure jumps to step S86. If not, the procedure jumps to step S87. In the step S86, the authentication file is authenticated and the boot ROM program executes a challenge procedure. In the step S87, the authentication file is not authenticated and the boot ROM program resets the electronic device 82 or halts operation of the electronic device 82. It is to be understood that, as the electronic device 82 being the same as that 33 of FIG. 6, the first value is different from the hash value when the employed hash function is different from one utilized in step S709 of FIG. 7, the stored public key is not the second public key of step S708 of FIG. 7, or the encrypted value is different from that generated by the S710 of FIG. 7.

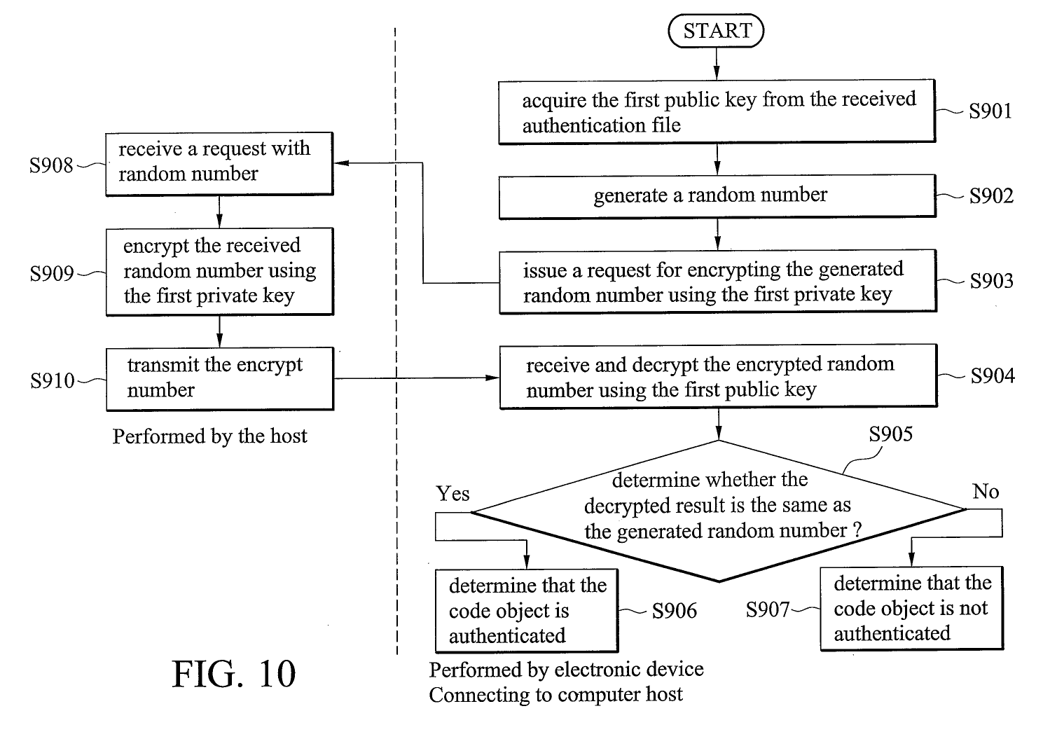

FIG. 10 is a flowchart of an embodiment of the challenge procedure according to the present invention. In the step S901, the boot ROM program acquires the public key from the authentication file. In the step S902, the boot ROM program generates a random number and issues a request for encrypting the generated random number in the step S903. When the computer host 81 receives the request in step S908, the computer host 81 acquires the private key in the server 85 or dongle 86 and encrypts the received random number using the acquired private key in the step S909. In step S910, the computer host 810 generates and transmits the encrypted number to the electronic device 82. In the step 904, the boot ROM program receives and decrypts the encrypted number by the public key (may be the first public key of FIG. 7) stored in the electronic device 82, and the boot ROM program determines whether the decrypted result is the same as the generated random number in step S905. If yes, the procedure jumps to step S906 and the boot ROM program transfers the control to the tool 84. If not, the procedure jumps to step S907 and the boot ROM program resets the electronic device 82 or halts operation of the electronic device 82. It is to be understood that, as the electronic device 82 being the same as that 33 of FIG. 6, the decrypted result is different from the generated random value when the public key is different from one received in step S705 of FIG. 7, the private key is different from that generated by step S705 of FIG. 7, or the computer host 81 is not the tool consumer 31 of FIG. 3.

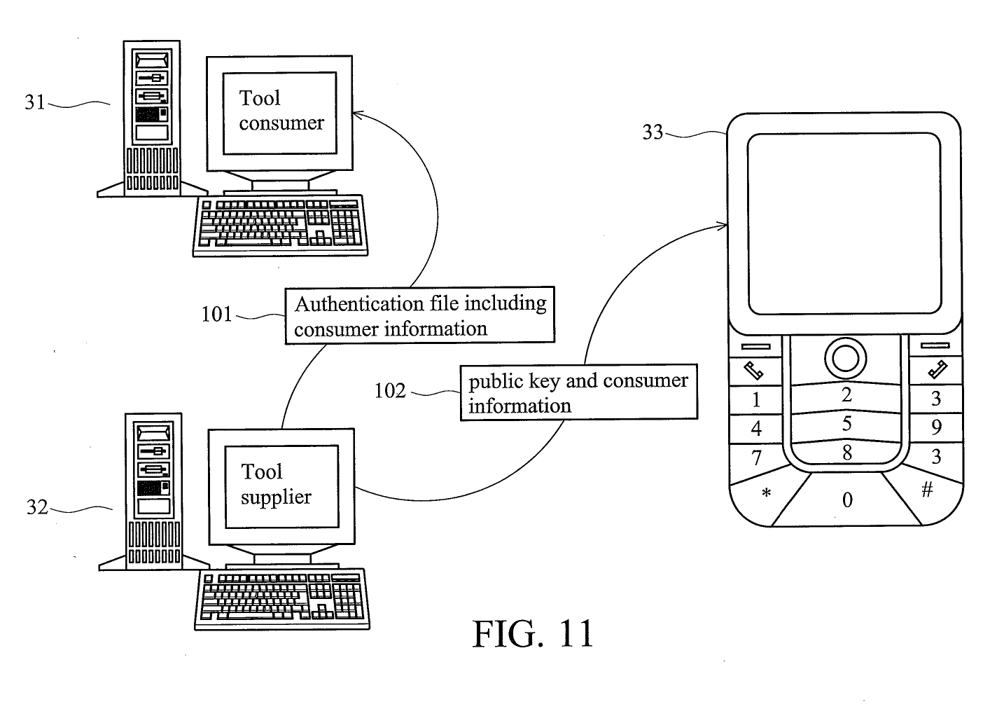

FIG. 11 is a schematic diagram of the process for the generation of the authentication file which is applied in a third embodiment of the validation mechanism according to the invention. In this embodiment, the validation mechanism is applied between the mobile phone 33 and the tool consumer 31, and the tool supplier 32 generates and transmits an authentication file 101 comprising the customer information to the tool consumer 31. The tool supplier 32 further generates a pair of a public key 102 and a private key using a key generator and transmits the public key 102 and the customer information to the mobile phone 33. The public key 102 and the customer information are stored in the boot ROM, internal ROM, internal RAM, external RAM or external flash inside the mobile phone 33. The authentication file 101 comprises content and encrypted value, wherein the content comprises target programs which the tool consumer 31 wants to execute in the mobile phone 33, the customer information of the tool consumer 31 or the combination. Details of encrypted value generation are described in the following. The tool supplier 32 first provides customer information corresponding to the tool supplier 31 and encapsulates the provided one into content of the authentication file 101. The tool supplier 32 uses a hash function to generate a hash value of the content. Then, the tool supplier 32 uses the generated private key to encrypt the hash value so as to generate the encrypted value.

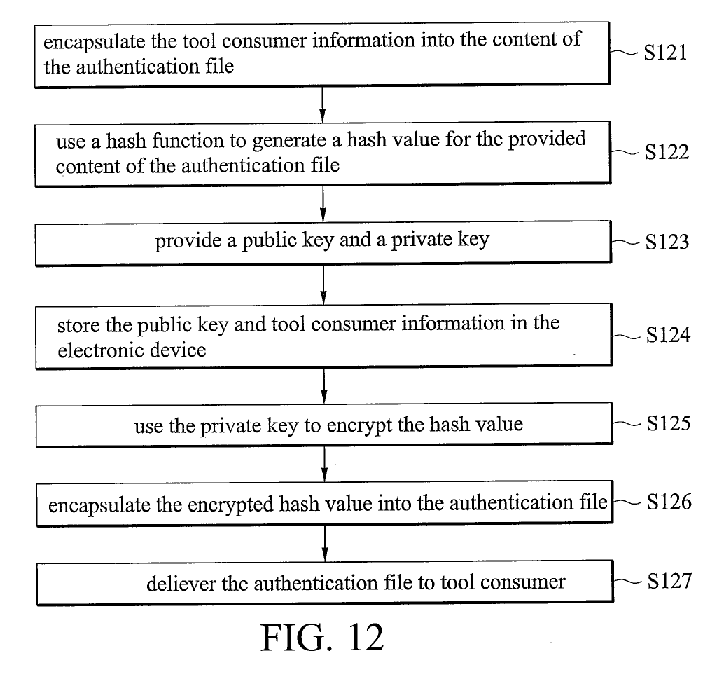

FIG. 12 is a flowchart of the process for the generation of the authentication file which is applied in the third embodiment of the validation mechanism according to the invention. In the embodiment, the flowchart is illustrated with the elements shown in FIG. 11. At beginning, in step S121, the tool supplier 32 encapsulates the customer information corresponding to the tool consumer 31 into the content of the authentication file 101. In the step S122, the tool supplier 32 generates a hash value for the provided content by using a hash function, wherein the hash function can be implemented by software or hardware. In the step S123, the tool supplier 32 provides the public key 102 and a private key using a key generator. In step S124, and the tool supplier 32 stores the public key 102 and the customer information in the mobile phone 33, wherein the public key 102 and the customer information are pre-burned in a ROM of the mobile phone 33 or are programmed in the boot-up program of the mobile phone 33. After the hash value is generated, the tool supplier 32 encrypts the hash value by using the private key in step S125. In the step S126, the tool supplier 32 then encapsulates the encrypted hash value into the authentication file 101 and delivers the authentication file 101 to the tool consumer 31 in the step S127.

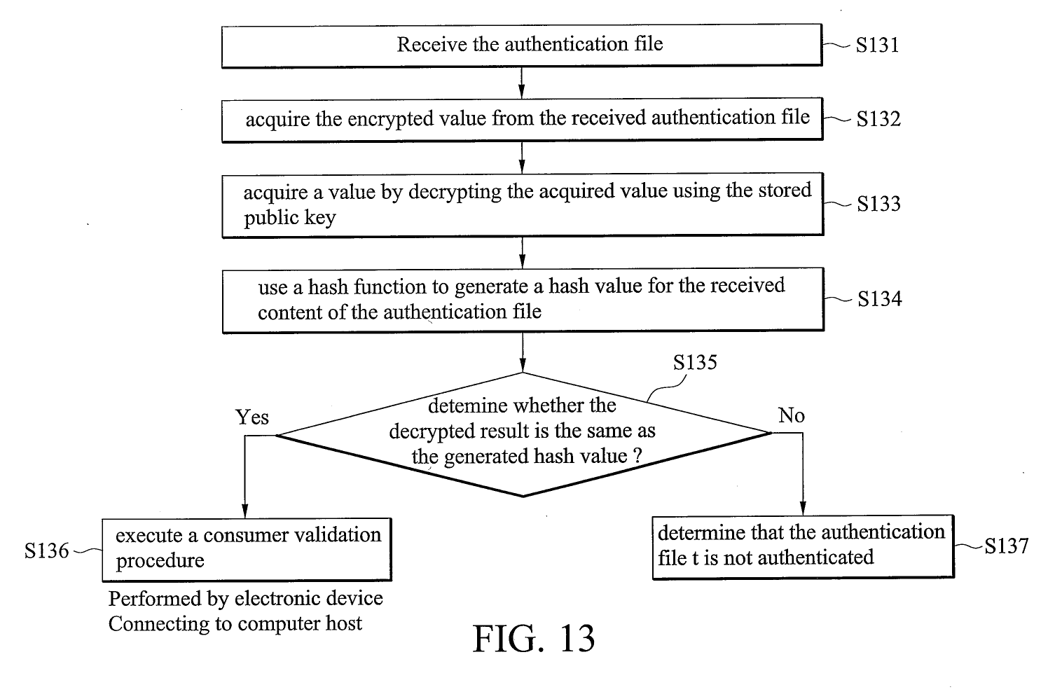

FIG. 13 is a flowchart of the third embodiment of the verification of the authentication file according to the invention. In the embodiment, the flowchart is illustrated with the elements shown in FIG. 8. When the electronic device 82 detects that the electronic device 82 is connected to the computer host 81, the verification procedure is applied. In the step S131, the boot ROM program receives the authentication file from the computer host 81 and acquires the encrypted value from the received authentication file in the step S132. The authentication file may be generated using the process illustrated in FIG. 12. The boot ROM program then uses the stored public key to decrypt the encrypted value to acquire a first value in the step S133. In step S134, the boot ROM program generates a hash value of the content of the authentication file by using the hash function, wherein the hash function may be the same as the described hash function in FIGS. 11 and 12. In the step S135, the boot ROM program determines whether the first value is the same as the hash value. If yes, the procedure jumps to step S136. If not, the procedure jumps to step S137. In the step S136, the authentication file is authenticated and the boot ROM program executes a customer information validation procedure. In the step S137, the authentication file is not authenticated and the boot ROM 83 resets or halts operation of the electronic device 82. It is to be understood that, as the electronic device 82 being the same as that 33 of FIG. 11, the first value is different from the hash value when the employed hash function is different from one utilized in step S122 of FIG. 2, the stored public key is not the public key of step S123 of FIG. 12, or the encrypted value is different from that generated by the S125 of FIG. 12.

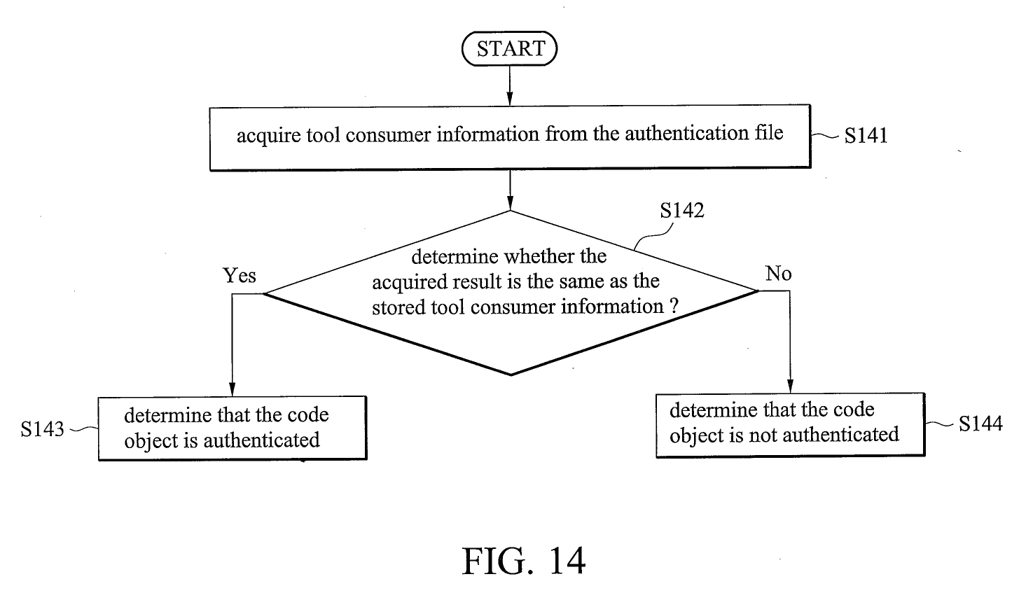

FIG. 14 is a flowchart of an embodiment of the customer information validation procedure according to the present invention. In the step S141, the boot ROM program acquires the customer information from the authentication file and determines whether the customer information is the same as the pre-stored customer information in the electronic device 82. If yes, the procedure jumps to the step S143, the authentication file and the tool 84 is authenticated by the boot ROM program, and the boot ROM program transfers the control to the tool 82. If not, the procedure jumps to the step S144, and the boot ROM program resets the electronic device 82 or halts operation of the electronic device 82.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. An apparatus for downloading and/or executing programs from a tool resident on a computer host, comprising:
an external flash memory storing a program;
a processor validating the tool when detecting that the computer host connects to the apparatus, and permitting the computer host to update the program of the external flash memory after determining that the tool has been successfully verified.

2. The apparatus as claimed in claim 1, further comprising a boot ROM storing an authentication program to validate the tool.

3. The apparatus as claimed in claim 1, wherein if the apparatus does not detect that the computer host connects to the apparatus, the processor directly executes the program stored in the external flash memory.

4. The apparatus as claimed in claim 1, further comprising an external random access memory (RAM), wherein if the apparatus does not detect that the computer host connects to the apparatus, the processor directly executes programs stored in the external RAM.

5. The apparatus as claimed in claim 1, further comprising:
a public key,
wherein during the validation of the tool, the processor further receives a code object comprising content and encrypted value from the tool, acquires the encrypted value from the code object, acquires a decrypted value by decrypting the encrypted value using the public key, generates a hash value of the content of the code object using a hash function, and determines the tool has been successfully verified when the hash value is the same as the decrypted value.

6. The apparatus as claimed in claim 5, wherein the computer host updates the program of the apparatus when obtaining the permission.

7. The apparatus as claimed in claim 5, wherein the hash function turns the content into the hash value in a fixed-sized and relatively small-sized.

8. The apparatus as claimed in claim 5, wherein the code object is an authentication file.

9. The apparatus as claimed in claim 8, wherein the stored public key is a second public key, the authentication file comprises a first public key and the encrypted value.

10. The apparatus as claimed in claim 9, wherein the second public key is stored in a boot ROM, internal ROM, internal RAM, external RAM or external flash thereof.

11. The apparatus as claimed in claim 9, wherein during the validation of the tool, the processor further generates a random number and issues a request for encrypting the generated random number to the computer host, receives an encrypted number in response to the request, decrypts the encrypted number by using the first public key, determines whether the decrypted result is the same as the generated random pattern, and if so, transfers the control to the computer host.

12. The apparatus as claimed in claim 8, wherein the authentication file comprises customer information, and the encrypted value.

13. The apparatus as claimed in claim 12, further comprising a pre-stored customer information, wherein during the validation of the tool, the processor determines whether the customer information of the authentication file is the same as the pre-stored customer information, and if so, transfers the control to the computer host.

14. A verification method for a tool resident on a computer host, wherein an apparatus downloads and/or executes programs from the tool, the method comprising:
transmitting a code object comprising content and a encrypted value to the apparatus;
gaining permission to update a program of the apparatus after the apparatus determines that the content matches the encrypted value; and
updating the program of the apparatus when obtaining the permission.

15. The verification method as claimed in claim 14, wherein the apparatus resets or halts when the apparatus determines that the content does not match the encrypted value.

16. The verification method as claimed in claim 14, wherein the content matches the encrypted value when a hash value of the content is the same as a decrypted value of the encrypted value by using a public key pre-stored in the apparatus.

17. The verification method as claimed in claim 16, wherein the code object is an authentication file comprising a first public key, and the pre-stored public key is a second public key, the method further comprising:
receiving a random number from the apparatus;
receiving a request for encrypting the received random number;
encrypting the received random number using a first private key corresponding to the first public key to generate an encrypted number;
transmitting the encrypted number to the apparatus; and
gaining permission to update the program of the apparatus after the apparatus determines that the encrypted number matches the random number.

18. The verification method as claimed in claim 17, wherein the encrypted number matches the random number when a decrypted number of the encrypted number by using the first public key is the same as the random number.

19. The verification method as claimed in claim 16, wherein the code object is an authentication file comprising a customer information, the method comprising:
gaining permission to update the program of the apparatus after the apparatus determines that the customer information of the authentication file is the same as a pre-stored customer information.
